(19) United States
(12) Patent Application Publication
(10) Pub. No.: US 2017/0171574 A1
(43) Pub. Date: Jun. 15, 2017

(54) METHOD AND SYSTEM FOR SWITCHING VIDEO LIVE BROADCASTING TO ON-DEMAND BROADCASTING

(71) Applicants: LE HOLDINGS (BEIJING) CO., LTD., Beijing (CN); LECLOUD COMPUTING CO., LTD, Beijing (CN)

(72) Inventors: Zongrui JIN, Beijing (CN); Junshi LIU, Beijing (CN); Junwei WU, Beijing (CN)

(21) Appl. No.: 15/246,150

(22) Filed: Aug. 24, 2016

Related U.S. Application Data
(63) Continuation of application No. PCT/CN2016/088835, filed on Jul. 6, 2016.

(30) Foreign Application Priority Data
Dec. 15, 2015 (CN) 201510933021.3

(51) Int. Cl. H04N 21/234; G06F 17/30; H04N 21/232; H04N 21/84; H04N 21/472; H04N 21/438

(52) U.S. Cl. CPC H04N 21/234; H04N 21/47202; H04N 21/4383; H04N 21/232; H04N 21/84; G06F 17/3082

(57) ABSTRACT

A method, system and non-transitory computer-readable storage medium for switching video live broadcasting to on-demand broadcasting are provided. The method includes: receiving a live broadcasting to on-demand broadcasting conversion request, and parsing a video characteristic parameter of a video to be broadcast on demand, querying an index table to determine a storage address of a video file corresponding to the video characteristic parameter of the video to be broadcast on demand; finding a corresponding source live broadcasting video file based on the determined storage address of the video file, and generating an on-demand broadcasting file by use of the corresponding source live broadcasting video file.

### CROSS REFERENCE TO RELATED APPLICATIONS

This application is a continuation of International Application No. PCT/CN2016/088835, filed on Jul. 6, 2016, which is based upon and claims priority to Chinese Patent Application No. 201510933021.3, filed on Dec. 15, 2015, the entire contents of both of which are incorporated herein by reference.

### TECHNICAL FIELD

Embodiments of the present disclosure relate to the field of video technologies, and more particularly to a method for switching video live broadcasting to on-demand broadcasting and system.

### BACKGROUND

There are two kinds of network video playing modes, namely, live broadcasting and on-demand broadcasting. Video live broadcasting means that a video is produced and broadcast simultaneously along with an occurrence and development course of an event; that is, the production and the broadcasting of the video are simultaneous. Video on-demand broadcasting states that a produced video is broadcast according to the needs of a user; that is, the production and the broadcasting of the video are non-simultaneous. Sometimes, the user may need to covert between live broadcasting and on-demand broadcasting when he/she is watching a video. For example, when watching a video live broadcasting content from a site, he/she may need to re-watch a former fragment in live broadcasting suddenly to relive that wonderful moment.

### SUMMARY

The embodiments of the present disclosure provide a method, system and computer-readable medium for switching video live broadcasting to on-demand broadcasting.

A method for switching video live broadcasting to on-demand broadcasting is provided. The method may include: receiving a live broadcasting to on-demand broadcasting conversion request, and parsing a video characteristic parameter of a video to be broadcast on demand, querying an index table which stores a correspondence between video characteristic parameters and storage addresses of source live broadcasting video files to determine a storage address of a video file corresponding to the video characteristic parameter of the video to be broadcast on demand, finding a corresponding source live broadcasting video file based on the determined storage address of the video file; and generating an on-demand broadcasting file by use of the corresponding source live broadcasting video file.

A system for switching video live broadcasting to on-demand broadcasting is provided. The system may include: at least one processor, and a memory communicably connected with the at least one processor for storing instructions executable by the at least one processor, wherein execution of the instructions by the at least one processor causes the at least one processor to: receive a live broadcasting to on-demand broadcasting conversion request, parse a video characteristic parameter of a video to be broadcast on demand, query an index table which stores a correspondence between video characteristic parameters and storage addresses of source live broadcasting video files to determine a storage address of a video file corresponding to the video characteristic parameter of the video to be broadcast on demand, and find a corresponding source live broadcasting video file based on the determined storage address of the video file, and generate an on-demand broadcasting file by use of the corresponding source live broadcasting video file.

A non-transitory computer-readable storage medium storing executable instructions for switching video live broadcasting to on-demand broadcasting is provided. The executable instructions, when executed by a processor, may cause the processor to: receive a live broadcasting to on-demand broadcasting conversion request, and parse a video characteristic parameter of a video to be broadcast on demand, query an index table which stores a correspondence between video characteristic parameters and storage addresses of source live broadcasting video files to determine a storage address of a video file corresponding to the video characteristic parameter of the video to be broadcast on demand, find a corresponding source live broadcasting video file based on the determined storage address of the video file, and generate an on-demand broadcasting file by use of the corresponding source live broadcasting video file.

It should be understood that both the foregoing general description and the following detailed description are exemplary and explanatory only and are not restrictive of the disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

In order to more clearly illustrate the embodiments of the present disclosure, figures to be used in the embodiments will be briefly introduced in the following. Apparently, figures in the following description are some embodiments of the present disclosure, and other figures can be obtained by those skilled in the art based on these figures without inventive efforts.

FIG. 1 shows a flow chart of a method for switching video live broadcasting to on-demand broadcasting according to an embodiment of the present disclosure;

FIG. 2 shows a schematic structural drawing of a system for switching video live broadcasting to on-demand broadcasting according to an embodiment of the present disclosure; and

FIG. 3 shows a schematic structural drawing of electronic equipment according to an embodiment of the present disclosure.

### DETAILED DESCRIPTION

In order to make the purpose, technical solutions, and advantages of the embodiments of the disclosure more clearly, technical solutions of the embodiments of the present disclosure will be described clearly and completely in conjunction with the figures. Obviously, the described embodiments are merely part of the embodiments of the present disclosure, but not all embodiments. Based on the embodiments of the present disclosure, other embodiments obtained by the ordinary skill in the art without inventive efforts are within the scope of the present disclosure.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may include used herein to describe various information, the information should not be limited by these terms. These terms are only used to distinguish one category of information from another. For example, without departing from the scope of the present disclosure, first information may include termed as second information; and similarly, second information may also be termed as first information. As used herein, the term “if” may include understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

In order to achieve the user experience of live broadcasting to on-demand broadcasting conversion, a solution is that a video service provider supplies a live broadcasting system for processing a user live broadcasting request and an on-demand broadcasting system for processing a user on-demand broadcasting request. The live broadcasting system and the on-demand broadcasting system provided by the video service provider are communicated via an interface. The live broadcasting system sends a source live broadcasting video file to the on-demand broadcasting system, which is realized by using the live broadcasting system to receive an on-demand broadcasting to live broadcasting conversion instruction from the on-demand broadcasting system and acquire the source live broadcasting video file based on the on-demand broadcasting to live broadcasting conversion instruction from the on-demand broadcasting system, and then an on-demand broadcasting file is generated in the on-demand broadcasting system based on the source live broadcasting video file.

Actually, during the implementation of the present disclosure, the inventor finds that generally, live broadcasting to on-demand broadcasting conversion service providers will take a network transmission speed between the live broadcasting system and the on-demand broadcasting system as a significant factor influencing video live broadcasting to on-demand broadcasting conversion when providing a live broadcasting to on-demand broadcasting conversion service, and always tend to optimize the network transmission speed between the live broadcasting system and the on-demand broadcasting system to the greatest extent, while ignoring a fact that the on-demand broadcasting system has to spend time querying a system database based on a received live broadcasting to on-demand broadcasting conversion instruction to obtain the source live broadcasting video file.

However, in large internet companies, the number of source live broadcasting video files stored in the system database can reach more than one million, so that the system resources are severely consumed during finding a source live broadcasting video file matched with the live broadcasting to on-demand broadcasting conversion instruction from the numerous sources live video files. Meanwhile, the system may repeatedly query a source live broadcasting video file in an occupied state, which will even cause the system to collapse in severe conditions.

Finding the source live broadcasting video file matched with the live broadcasting to on-demand broadcasting conversion instruction from the numerous sources live video files reduces the conversion efficiency between live broadcasting videos and on-demand broadcasting videos. If the system repeatedly queries a source live broadcasting video file in an occupied state, lots of time will be consumed during querying. Field testing results indicate that the responding time of the on-demand broadcasting system will be 10's or more in a process for finding one of millions of source live broadcasting video files and generating a corresponding on-demand broadcasting video, which delays the generating time of the on-demand broadcasting video corresponding to a source live broadcasting video to be converted. As s result, the user experience is seriously affected.

The embodiments of the present disclosure provide a method for switching video live broadcasting to on-demand broadcasting and system to overcome a defect that a video live broadcasting to on-demand broadcasting conversion speed is too slow, so as to accelerate the video live broadcasting to on-demand broadcasting conversion speed.

In the method for switching video live broadcasting to on-demand broadcasting and system, a source live broadcasting video file is acquired by querying an established index table which includes video characteristic parameters and storage addresses based on a video characteristic parameter in a received live broadcasting to on-demand broadcasting conversion request.

Compared with a scheme that the source live broadcasting video file is acquired by querying a plurality of source live broadcasting video files in a system database based on the received live broadcasting to on-demand broadcasting conversion request, global retrieval and querying of the system database can be eliminated, and repeated querying of a source live broadcasting video file in an occupied state is avoided, so that the consumption of the system resources in a video live broadcasting to on-demand broadcasting conversion process is reduced, a system collapsing possibility in the video live broadcasting to on-demand broadcasting conversion process is effectively decreased, the conversion speed from the source live broadcasting video file to an on-demand broadcasting file is greatly accelerated, and the generating time difference between the on-demand file and the source live broadcasting video file is reduced. Field testing results indicate that a responding time for finding and calling one of millions of source live broadcasting video files and generating a corresponding on-demand broadcasting video is at a 10-second level, but under the same network transmission speed, by applying the method and system provided by the embodiments of the present disclosure, the responding time for finding and calling one of millions of source live broadcasting video files and generating the corresponding on-demand broadcasting video is at a millisecond level.

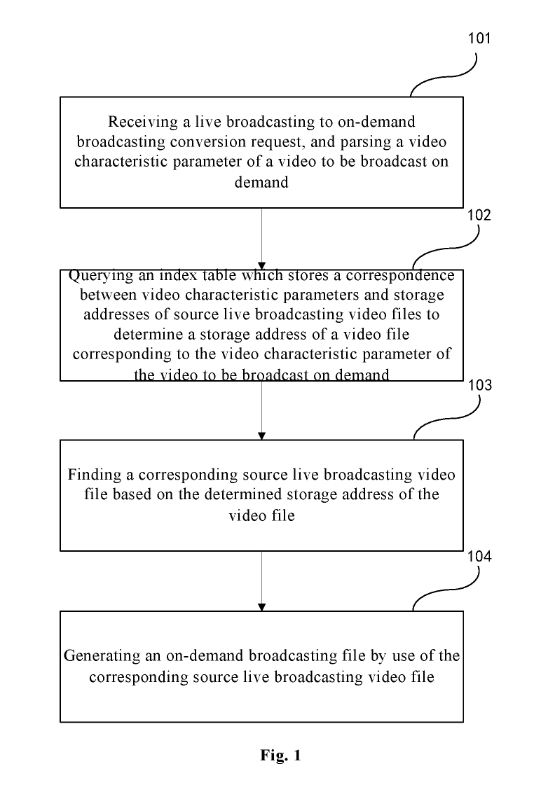

FIG. 1 shows a flow chart of a method for switching video live broadcasting to on-demand broadcasting according to an embodiment of the present disclosure. The method includes:

S101: receiving by an on-demand broadcasting system a live broadcasting to on-demand broadcasting conversion request, and parsing by the on-demand broadcasting system a video characteristic parameter of a video to be broadcast on demand;

S102: querying by the on-demand broadcasting system an index table which stores a correspondence between video characteristic parameters and storage addresses of source live broadcasting video files to determine a storage address of a video file corresponding to the video characteristic parameter of the video to be broadcast on demand;

S103: finding by the on-demand broadcasting system a corresponding source live broadcasting video file based on the determined storage address of the video file; and

S104: generating by the on-demand broadcasting system an on-demand broadcasting file by use of the corresponding source live broadcasting video file.

In the method for switching video live broadcasting to on-demand broadcasting provided by the above embodiment, the on-demand broadcasting system acquires a source live broadcasting video file by establishing an index table which includes video characteristic parameters and storage addresses and querying the index table based on a video characteristic parameter in a received live broadcasting to on-demand broadcasting conversion request. Compared with a scheme that the source live broadcasting video file is acquired by querying a plurality of source live broadcasting video files in a system database based on the received live broadcasting to on-demand broadcasting conversion request, global retrieval and querying of the system database can be eliminated, and meanwhile, repeated querying of a source live broadcasting video file in an occupied state is avoided, so that the consumption of the system resources in a video live broadcasting to on-demand broadcasting conversion process is reduced, a system collapsing possibility in the video live broadcasting to on-demand broadcasting conversion process is effectively decreased, the conversion speed from the source live broadcasting video file to an on-demand broadcasting file is greatly accelerated, and the generating time difference between the on-demand file and the source live broadcasting video file is reduced.

Field testing results indicate that a responding time for finding and calling one of millions of source live broadcasting video files and generating a corresponding on-demand broadcasting video is at a 10-second level, but under the same network transmission speed, by applying the method provided by the present embodiment, the responding time for finding and calling one of millions of source live broadcasting video files and generating the corresponding on-demand broadcasting video is at a millisecond level.

As a further optimization of the method shown in FIG. 1 according to an embodiment, in another embodiment, the method further includes: acquiring by an on-demand broadcasting system a video characteristic parameter and a storage address of a source live broadcasting video file, and generating an index table including the video characteristic parameter and the storage address of the source live broadcasting video file.

With respect to the method according to a preferred embodiment, after receiving and storing a source live broadcasting video file every time, the on-demand broadcasting system acquires the video characteristic parameter and the storage address of the source live broadcasting video file, and fills the index table with the video characteristic parameter and the storage address.

According to the above embodiment, the index table is updated in real time, and on-demand broadcasting files corresponding to source live broadcasting video files in a system database are synchronously updated in real time.

As a further optimization of the method shown in FIG. 1, generating by the on-demand broadcasting system an on-demand broadcasting file by use of the corresponding source live broadcasting video file includes: encapsulating by the on-demand broadcasting system source live broadcasting video files with different code rates to an on-demand broadcasting file allowing code rate conversion.

If a plurality of source live broadcasting files with different definitions are generated in once live broadcasting, the source live broadcasting files with the same video characteristic parameter are encapsulated to generate an on-demand broadcasting file with different definitions to be converted. The method provided by the preferred embodiment of the present disclosure can quickly find a plurality of source live broadcasting video files to be encapsulated, and further shortens the generating time of the on-demand broadcasting file corresponding to the above source live broadcasting video files.

As a further optimization of the method shown in FIG. 1 according to an embodiment, a video characteristic parameter is a media asset ID.

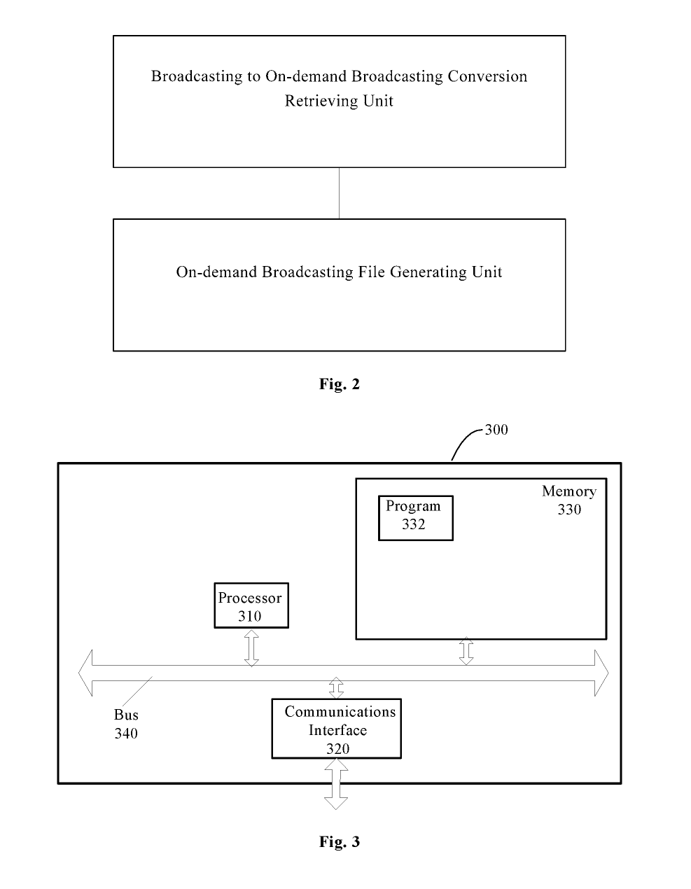

FIG. 2 shows a schematic structural drawing of a system for switching video live broadcasting to on-demand broadcasting according to an embodiment of the present disclosure. The system includes: a live broadcasting to on-demand broadcasting conversion retrieving unit configured to receive a live broadcasting to on-demand broadcasting conversion request, parse a video characteristic parameter of a video to be broadcast on demand, query an index table to determine a storage address of a video file corresponding to the video characteristic parameter of the video to be broadcast on demand, and find a corresponding source live broadcasting video file based on the determined storage address of the video file; and an on-demand broadcasting file generating unit configured to generate an on-demand broadcasting file by use of the corresponding source live broadcasting video file.

In the system for switching video live broadcasting to on-demand broadcasting provided by the above embodiment, the on-demand broadcasting system acquires a source live broadcasting video file by establishing an index table which includes video characteristic parameters and storage addresses and querying the index table based on a video characteristic parameter in a received live broadcasting to on-demand broadcasting conversion request. Compared with a scheme that the source live broadcasting video file is acquired by querying a plurality of source live broadcasting video files in a system database based on the received live broadcasting to on-demand broadcasting conversion request, global retrieval and querying of the system database can be eliminated, and meanwhile, repeated querying of a source live broadcasting video file in an occupied state is avoided, so that the consumption of the system resources in a video live broadcasting to on-demand broadcasting conversion process is reduced, a system collapsing possibility in the video live broadcasting to on-demand broadcasting conversion process is effectively decreased, the conversion speed from the source live broadcasting video file to an on-demand broadcasting file is greatly accelerated, and the generating time difference between the on-demand file and the source live broadcasting video file is reduced.

Field testing results indicate that a responding time for finding and calling one of millions of source live broadcasting video files and generating a corresponding on-demand broadcasting video is at a 10-second level, but under the same network transmission speed, by applying the system provided by the present embodiment, the responding time for finding and calling one of millions of source live broadcasting video files and generating the corresponding on-demand broadcasting video is at a millisecond level.

In the present embodiment, the system for switching video live broadcasting to on-demand broadcasting may be a separate server or server cluster. The above units may be separate servers or server clusters. Here, interaction between the above units is that between the servers or server clusters corresponding to the units, and the servers or server clusters corresponding to the units together form a system for switching video live broadcasting to on-demand broadcasting provided by the present disclosure.

Particularly, the system for switching video live broadcasting to on-demand broadcasting formed by the servers or server clusters corresponding to the units includes: a live broadcasting to on-demand broadcasting conversion retrieving server or server cluster configured to receive a live broadcasting to on-demand broadcasting conversion request, parse a video characteristic parameter of a video to be broadcast on demand, query an index table to determine a storage address of a video file corresponding to the video characteristic parameter of the video to be broadcast on demand, and find a corresponding source live broadcasting video file based on the determined storage address of the video file; and an on-demand broadcasting file generating server or server cluster configured to generate an on-demand broadcasting file by use of the corresponding source live broadcasting video file.

In an alternative embodiment, several modules in the above multiple modules together form a server or server cluster. For example, the live broadcasting to on-demand broadcasting conversion retrieving unit and the on-demand broadcasting file generating form a server or server cluster.

As a further optimization of the system provided by the present disclosure, in another embodiment, the system further includes an index table generating unit configured to acquire a video characteristic parameter and a storage address of a source live broadcasting video file, and generate an index table including the video characteristic parameter and the storage address of the source live broadcasting video file.

According to the system provided by the preferred embodiment of the present disclosure, the index table is updated in real time, and on-demand broadcasting files corresponding to source live broadcasting video files in a system database are synchronously updated in real time.

The system for switching video live broadcasting to on-demand broadcasting provided by the present embodiment includes a live broadcasting to on-demand broadcasting conversion retrieving unit, an on-demand broadcasting file generating unit and an index table generating unit. The above units may be separate servers or server clusters. Here, interaction among the above units is that among the servers or server clusters corresponding to the units, and the servers or server clusters corresponding to the units together form a system for switching video live broadcasting to on-demand broadcasting provided by the present disclosure.

Particularly, the system for switching video live broadcasting to on-demand broadcasting formed by the servers or server clusters corresponding to the units includes: an index table generating server or server cluster configured to acquire a video characteristic parameter and a storage address of a source live broadcasting video file, and generate an index table including the video characteristic parameter and the storage address of the source live broadcasting video file; a live broadcasting to on-demand broadcasting conversion retrieving server or server cluster configured to receive a live broadcasting to on-demand broadcasting conversion request, parse a video characteristic parameter of a video to be broadcast on demand, query an index table to determine a storage address of a video file corresponding to the video characteristic parameter of the video to be broadcast on demand, and find a corresponding source live broadcasting video file based on the determined storage address of the video file; and an on-demand broadcasting file generating server or server cluster configured to generate an on-demand broadcasting file by use of the corresponding source live broadcasting video file.

With respect to a preferred embodiment of the present disclosure, more specifically, a video live broadcasting to on-demand broadcasting conversion service provider provides a live broadcasting sub-system for processing a user live broadcasting access request and an on-demand broadcasting sub-system for processing a user on-demand broadcasting access request. The system for switching video live broadcasting to on-demand broadcasting is arranged in the on-demand broadcasting sub-system. The index table generating unit is arranged in a communication interface, which is used for receiving a source live broadcasting video file, of the on-demand broadcasting sub-system. The communication interface is used for information interaction with the live broadcasting sub-system. Thus, while a source live broadcasting file is transmitted to the on-demand broadcasting system, video characteristic information and an address to be stored of the source live broadcasting video file are recorded in the index table, so that an index table generation operation is simplified, and real-time and synchronous operations of the source live broadcasting file and an on-demand file are realized.

As a further optimization of the system shown in FIG. 2 according to an embodiment, an on-demand broadcasting file generating unit is configured to encapsulate source live broadcasting video files with different code rates to an on-demand broadcasting file allowing code rate conversion.

If a plurality of source live broadcasting files with different definitions is generated in once live broadcasting, the source live broadcasting files with the same video characteristic parameter are encapsulated to generate an on-demand broadcasting file with different definitions to be converted. The system provided by the preferred embodiment of the present disclosure can quickly find a plurality of source live broadcasting video files to be encapsulated, and further shortens the generating time of the on-demand broadcasting file corresponding to the above source live broadcasting video files.

As an optimization of the system shown in FIG. 2 according to an embodiment, a video characteristic parameter is a media asset ID.

In the embodiments of the present disclosure, related function modules and units can be implemented by a hardware processor.

The embodiments of the present disclosure also provide a non-transitory computer-readable storage medium. One or more programs including execution instructions are stored in the storage medium, and the execution instructions can be read and executable by electronic equipment (including but not limited to a computer, a server, network equipment or the like) for executing related steps in the above method according to the embodiments. The steps include: receiving a live broadcasting to on-demand broadcasting conversion request, and parsing a video characteristic parameter of a video to be broadcast on demand; querying an index table which stores a correspondence between video characteristic parameters and storage addresses of source live broadcasting video files to determine a storage address of a video file corresponding to the video characteristic parameter of the video to be broadcast on demand; finding a corresponding source live broadcasting video file based on the determined storage address of the video file; and generating an on-demand broadcasting file by use of the corresponding source live broadcasting video file.

FIG. 3 shows a schematic structural drawing of electronic equipment (including but not limited to a computer, a server, network equipment or the like) according to an embodiment of the present disclosure. The embodiments of the present application do not limit specific implementation of the electronic equipment, namely the video live broadcasting to on-demand broadcasting conversion device 300. The video live broadcasting to on-demand broadcasting conversion device 300 may include: a processor 310, a communications interface 320, a memory 330 and a communication bus 340.

The processor 310, the communications interface 320 and the memory 330 are communicated with one another via the communication bus 340.

The communications interface 320 is configured to communicate with a network element, such as a client.

The processor 310 is configured to execute a program 332 in the memory 330, and specifically, can execute the related steps in the above method according to the embodiments.

Particularly, the program 332 may include a program code including a computer operation instruction.

The processor 310 may be a central processing unit (CPU), an ASIC (Application Specific Integrated Circuit), or one or more integrated circuits configured to implement the embodiments of the present application.

The video live broadcasting to on-demand broadcasting conversion device according to the above embodiment includes: a memory configured to store a computer operation instruction, and a processor configured to execute the computer operation instruction stored in the memory so as to: receive a live broadcasting to on-demand broadcasting conversion request, and parse a video characteristic parameter of a video to be broadcast on demand; query an index table which stores a correspondence between video characteristic parameters and storage addresses of source live broadcasting video files to determine a storage address of a video file corresponding to the video characteristic parameter of the video to be broadcast on demand; find a corresponding source live broadcasting video file based on the determined storage address of the video file; and generate an on-demand broadcasting file by use of the corresponding source live broadcasting video file.

A non-transitory computer-readable storage medium storing executable instructions for switching video live broadcasting to on-demand broadcasting is provided. The executable instructions, when executed by a processor, may cause the processor to: receive a live broadcasting to on-demand broadcasting conversion request, and parse a video characteristic parameter of a video to be broadcast on demand, query an index table which stores a correspondence between video characteristic parameters and storage addresses of source live broadcasting video files to determine a storage address of a video file corresponding to the video characteristic parameter of the video to be broadcast on demand, find a corresponding source live broadcasting video file based on the determined storage address of the video file, and generate an on-demand broadcasting file by use of the corresponding source live broadcasting video file.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations.

The terms “module,” “sub-module,” “unit,” or “sub-unit” may include memory (shared, dedicated, or group) that stores code or instructions that can be executed by one or more processors.

Finally, it should be noted that, the above embodiments are merely provided for describing the technical solutions of the present disclosure, but not intended as a limitation. Although the present disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present disclosure.

What is claimed is:

1. A method for switching video live broadcasting to on-demand broadcasting, comprising:
receiving a live broadcasting to on-demand broadcasting conversion request, and parsing a video characteristic parameter of a video to be broadcast on demand;
querying an index table which stores a correspondence between video characteristic parameters and storage addresses of source live broadcasting video files to determine a storage address of a video file corresponding to the video characteristic parameter of the video to be broadcast on demand;
finding a corresponding source live broadcasting video file based on the determined storage address of the video file; and
generating an on-demand broadcasting file by use of the corresponding source live broadcasting video file.

2. The method of claim 1, further comprising:
acquiring a video characteristic parameter and a storage address of the source live broadcasting video file, and generating an index table comprising the video characteristic parameter and the storage address of the source live broadcasting video file.

3. The method of claim 1, wherein generating the on-demand broadcasting file by use of the corresponding source live broadcasting video file comprises:
encapsulating source live broadcasting video files with different code rates to an on-demand broadcasting file allowing code rate conversion.

4. The method of claim 1, wherein the video characteristic parameter is a video asset identification(ID).

5. A system for switching video live broadcasting to on-demand broadcasting, comprising:
at least one processor; and
a memory communicably connected with the at least one processor for storing instructions executable by the at least one processor, wherein execution of the instructions by the at least one processor causes the at least one processor to:
receive a live broadcasting to on-demand broadcasting conversion request, parse a video characteristic parameter of a video to be broadcast on demand, query an index table which stores a correspondence between video characteristic parameters and storage addresses of source live broadcasting video files to determine a storage address of a video file corresponding to the video characteristic parameter of the video to be broadcast on demand, and find a corresponding source live broadcasting video file based on the determined storage address of the video file; and
generate an on-demand broadcasting file by use of the corresponding source live broadcasting video file.

6. The system of claim 5, wherein the execution of the instructions by the at least one processor further causes the at least one processor to:
acquire a video characteristic parameter and a storage address of a source live broadcasting video file, and generate an index table comprising the video characteristic parameter and the storage address of the source live broadcasting video file.

7. The system of claim 5, wherein the instructions cause the at least one processor to generate the on-demand broadcasting file further cause the at least one processor to encapsulate a source live broadcasting video file with different code rates to an on-demand broadcasting file allowing code rate conversion.

8. The system of claim 5, wherein the video characteristic parameter is a video asset ID.

9. A non-transitory computer-readable storage medium storing executable instructions for switching video live broadcasting to on-demand broadcasting, wherein the executable instructions, when executed by a processor, cause the processor to:
receive a live broadcasting to on-demand broadcasting conversion request, and parse a video characteristic parameter of a video to be broadcast on demand;
query an index table which stores a correspondence between video characteristic parameters and storage addresses of source live broadcasting video files to determine a storage address of a video file corresponding to the video characteristic parameter of the video to be broadcast on demand;
find a corresponding source live broadcasting video file based on the determined storage address of the video file; and
generate an on-demand broadcasting file by use of the corresponding source live broadcasting video file.

10. The non-transitory computer-readable storage medium according to claim 9, wherein the executable instructions, when executed by the processor, further cause the processor to:
acquire a video characteristic parameter and a storage address of the source live broadcasting video file, and generate an index table comprising the video characteristic parameter and the storage address of the source live broadcasting video file.

11. The non-transitory computer-readable storage medium according to claim 9, wherein the executable instructions to cause the processor to generate the on-demand broadcasting file by use of the corresponding source live broadcasting video file, further cause the processor to:
encapsulate source live broadcasting video files with different code rates to an on-demand broadcasting file allowing code rate conversion.

12. The non-transitory computer-readable storage medium according to claim 9, wherein the video characteristic parameter is a video asset identification(ID).
